(19) United States
(12) Patent Application Publication
(10) Pub. No.: US 2008/0316221 A1
(43) Pub. Date: Dec. 25, 2008

(54) Down-sampled image display

(76) Inventor: Eric F. Aas, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/820,434

(22) Filed: Jun. 19, 2007

(51) Int. Cl. G06F 12/02

(52) U.S. Cl. 345/544

(57) ABSTRACT

A memory controller of an apparatus repeatedly retrieves a down-sampled file of a digitally captured image from a non-volatile memory for refresh of a raster display screen.

### BACKGROUND

Image capture systems such as photo and/or video cameras and/or recorders can allow instant and/or immediate review by a consumer of an image last taken such as a digital photo. The image capture system presents the image last taken on a display screen. The image capture system has a volatile memory buffer dedicated to storing the image last taken for presentation on the display screen.

### DESCRIPTION OF THE DRAWINGS

Features of exemplary implementations of the invention will become apparent from the description, the claims, and the accompanying drawings in which:

FIG. 1 is a representation of an implementation of an apparatus that comprises one or more of a sensor, a circuit, a user interface, a memory, a display, a power source, and/or one or more interfaces, and further illustrates one or more users

FIG. 2 is a representation of an exemplary logic flow for a storage in the memory of an image obtained by the circuit from the sensor, a down sampling of the image by the circuit, and a storage in the memory of the down-sampled image of an implementation of the apparatus of FIG. 1.

FIG. 3 is a representation of an exemplary logic flow for a retrieval from the memory of the down-sampled image by the circuit for a presentation on the display of an implementation of the apparatus of FIG. 2.

### DETAILED DESCRIPTION

Referring to the BACKGROUND section above, an exemplary feature of interest is instant review by the consumer of a last photo taken on the display screen. A volatile memory buffer can be dedicated to storing the last taken image for instant review on the display screen. Memory such as SRAM or DRAM may be employed for frame buffer storage to have sufficient bandwidth to meet the refresh needs, characteristics, and/or constraints of LCD displays. In an exemplary low cost system, an exemplary desire is to eliminate an intermediate memory buffer to reduce the system cost.

An exemplary implementation comprises a digital camera and/or one-time use digital camera. A liquid crystal display (LCD) as the display screen may need some form of frame buffer to store the image being displayed. An exemplary LCD display screen is refreshed from this buffer. An exemplary LCD is clocked at approximately fifteen (15) to thirty (30) MHz. Exemplary eight (8) bit NAND flash memory as non-volatile memory ma y be read up to, for example, approximately nine (9) Mbytes/second to seventeen (17) Mbytes/second. An exemplary implementation employs compression such as JPEG compression to accommodate the data rate mismatch and allow NAND flash memory to be used as a frame buffer for an LCD.

An exemplary digital camera system captures an image from the sensor and in real time processes this image to JPEG and stores the data to NAND flash memory. Exposure, white balance, and color parameters may be set based on previous image sensor exposures, for example, eliminating a need for intermediate storage of the entire raw image in SDRAM. The compressed data may be read out from the NAND flash memory to create a display image that may be compressed in JPEG and stored back into the NAND flash memory. The JPEG compressed display data may be decompressed on the fly and fed to the LCD repeatedly to maintain, meet, and/or satisfy exemplary refresh needs, characteristics, desires, and/or constraints of the LCD display.

By compressing the LCD display data, the NAND flash may be employed as a frame buffer for the LCD. An exemplary system may be constructed without a LCD frame buffer that employs volatile memory such as DRAM or SRAM, embedded or external. Reduction of need for volatile memory as the display buffer reduces cost of the system. Rather than a volatile memory buffer dedicated to the refresh of an instant review display screen on a digital image capture system and/or camera, an exemplary implementation continuously retrieves a down-sampled file of the image from non-volatile memory. An exemplary implementation saves the cost of the volatile memory that may otherwise be employed and/or needed for the buffer.

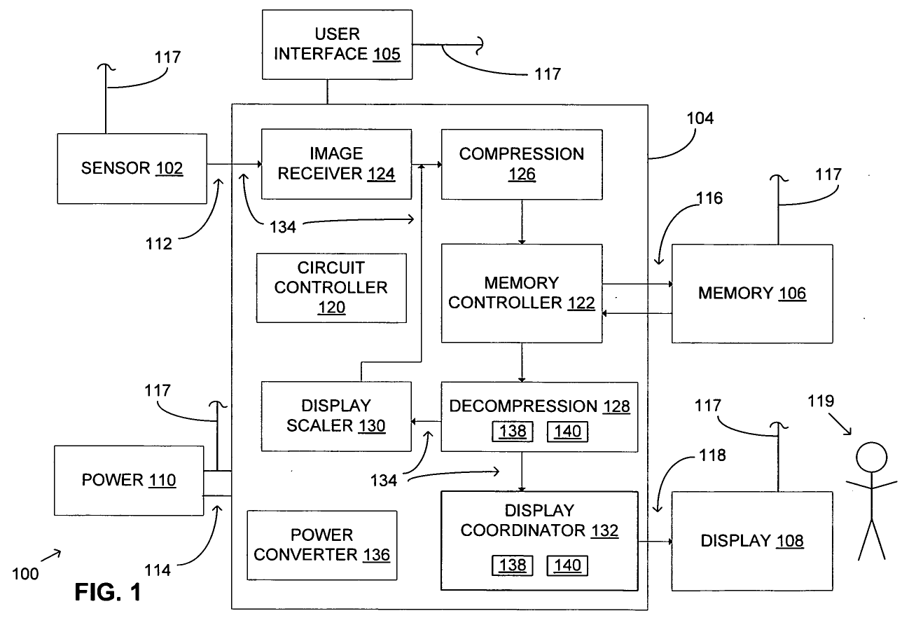

Turning to FIG. 1, an implementation of an apparatus 100 comprises one or more of a sensor 102, a circuit 104, a user interface 105, a storage and/or memory 106, a display 108, a power source 110, one or more interfaces 112, 114, 116, and/or 118, and/or one or more connections 117. The apparatus 100 comprises an image capture system and/or photo, digital, video camera and/or recorder, and/or one-time use system, camera, and/or recorder. One or more users 119 may operate, interact, and/or appear with the apparatus 100. Exemplary users 119 comprise an operator and/or consumer of the apparatus 100, a technician that services the apparatus 100, a subject, object, and/or target of a captured and/or taken image of the apparatus 100 and/or an image to be captured and/or taken by the apparatus 100, and/or a person.

The sensor 102 comprises an image sensor. The sensor 102 transmits one or more stationary or moving images of an object and/or target such as a user 119. The sensor 102 comprises a progressive sensor and/or sequentially transmits lines of each frame for an image. The sensor 102 employs a red-green-blue (RGB), cyan-magenta-yellow (CMY), and/or cyan-magenta-yellow-black (CMYK) approach and/or Bayer filter. The sensor 102 comprises an arrangement and/or grid of red, green, and blue detectors such as a row RGRGRGRG is followed by a row GBGBGBGB with that pattern repeated. Green is allocated more detectors than red and blue to better approximate sensitivity of a human eye.

The sensor 102 comprises a complementary metal-oxide semiconductor (CMOS) based image sensor or a charge-coupled device (CCD) based image sensor. An exemplary CMOS image sensor employs complementary and symmetrical pairs of p-type and n-type metal-oxide-semiconductor field-effect transistors (MOSFETs) for logic functions. An exemplary CCD image sensor comprises an integrated circuit with an array of linked and/or coupled light-sensitive capacitors.

The circuit 104 comprises an integrated circuit (IC) and/or an application specific integrated circuit (ASIC). The circuit 104 comprises one or more controllers such as circuit controller 120 and/or memory controller 122, an image receiver 124, an image compressor such as compression component and/or unit 126, an image decompressor such as decompression component and/or unit 128, display supporters such as display scaler 130 and/or display coordinator 132, or more connections 134, one or more power converters 136, and/or one or more buffers 138 and/or 140, for example, within decompression unit 128 and within display coordinator 132. The connections 134 comprise one or more of logic, control, data, information, and/or power connections, busses, leads, lines, pathways, and/or passages.

The image receiver 124 comprises an image pipeline. An exemplary image pipeline as the image receiver 124 serves to convert raw data and/or information of the image transmitted from the sensor 102 into a format that is suitable for presentation to the compression unit 126 for compression, for example, Joint Photographic Experts Group (JPEG) compression of the data and/or information as the image. An exemplary format input to the image receiver 124 from the sensor 102 comprises Bayer format, RGB format, or CMY format. An exemplary format output from the image receiver 124 comprises YCrCb and/or YCC format. The image receiver 124 encodes RGB information from the sensor 102 in a Bayer format that depends on the actual RGB colorants employed by the sensor 102. The image receiver 124 employs a series of image processing operations that produce an YCC 4:2:2 image. The image receiver 124 outputs YCC 4:2:2 format, for example, with gamma correction such as eight (8) bit gamma correction suitable for JPEG compression by the compression unit 126. The compression unit 126 comprises a Joint Photographic Experts Group (JPEG) compression unit.

The decompression unit 128 in an example comprises buffers 138 and 140. In another example, the buffers 138 and 140 are shared by and/or located outside the decompression unit 128 and the display coordinator 132 in the circuit 104. In a further example, the decompression unit 128 and the display coordinator 132 comprise respective sets of the buffers 138 and 140 such as is illustrated in FIG. 1 for explanatory purposes. In yet another example, one or more of the image receiver 124, the compression unit 126, the decompression unit 128, the display scaler 130, and/or the display coordinator 132 share the buffers 138 and 140.

The decompression unit 128 comprises a JPEG decompression unit. The decompression unit 128 and/or the display coordinator 132 comprise and/or employ one or more buffers 138 and/or 140 to store, for example, temporarily eight by eight (8×8) JPEG blocks such as to allow raster data to be sent to the display. Additional exemplary description is presented herein.

The display coordinator 132 serves to support the display 108. An exemplary display coordinator 132 comprises a raster graphics display coordinator. The display coordinator 132 comprises, for example, zero or more buffers 138 and/or 140 such as for filtering operations that may be employable for the display 108. Additional exemplary description is presented herein.

The memory 106 comprises flash or other type of non-volatile memory. The memory 106 retains information stored in the memory 106 when the memory 106 is not powered and/or when the memory 106 is powered at one or more relatively low levels. Flash memory as the memory 106 may be electrically erased and rewritten and/or reprogrammed such as by the user 119. Where the circuit 104 comprises an integrated circuit, the memory 106 comprises memory that is external and/or non-integrated with respect to the circuit 104. An exemplary NAND flash memory as the memory 106 employs tunnel injection for writing and tunnel release for erasing. The NAND flash memory employs a NAND digital logic gate, as will be appreciated by those skilled in the art.

The display 108 comprises a liquid crystal display (LCD) screen. The display 108 serves to present for viewing by the user 119 one or more of a raster graphics image, digital image, and/or bitmap. The display 108 employs a data file and/or structure to represent, for example, a generally rectangular grid of pixels and/or points of color. The display 108 presents an image as an array of pixels arranged in rows and columns. An exemplary display 108 comprises a quarter video graphics array (QVGA) LCD. An exemplary QVGA LCD as the display 108 comprises landscape mode and/or alignment two hundred forty by three hundred twenty (240×320) pixels (picture elements) resolution and/or portrait mode and/or alignment three hundred twenty by two hundred forty (320×240) pixels resolution.

An exemplary power source 110 comprises a power unit and/or one or more batteries. Exemplary battery chemistries comprise alkaline, nickel metal hydride battery (NiMH), or lithium ion. The sensor 102, the circuit 104, the user interface 105, the memory 106, and/or the display 108 comprise respective power converters 136 such as direct current to direct current (DC to DC or DC-DC) converters that serve to convert a battery voltage carried on a power bus as the connection 117, from the power source 110 to various voltages needed, desired, suited, and/or appropriate for the sensor 102, the circuit 104, the user interface 105, the memory 106, or the display 108. The circuit controller 120 turns the DC-DC converters 136 on and off, for example, depending on which elements and/or components of the system and/or apparatus 100 are selected, needed, and/or desired in various operating modes and/or states.

The power source 110 provides power to the sensor 102, the user interface 105, the memory 106, and the display 108 during active operation. During an inactive state, the power source 110 is turned off and provides no power to the sensor 102, the user interface 105, the memory 106, and the display 108. During a passive or sleep state, the power source 110 provides reduced power to one or more of, and no power to a remaining one or more of, the sensor 102, the user interface 105, the memory 106, and/or the display 108.

The interfaces 112, 114, 116, and/or 118 comprise one or more ports, connections, busses, leads, lines, pathways, and/or passages, for example, for logic, control, data, information, and/or power. The interface 114 comprises a power bus as an exemplary connection 117. The interface 114 comprises a control interface between the power unit 110 and the circuit 104. The circuit controller 120 serves to control a power bus as an exemplary connection 117. An exemplary flow of control by the circuit controller 120 in relation and/or with respect to the power bus as the connection 117 proceeds: over the interface 114 between the circuit 104 and the power source 110; over the interface 112 between the circuit 104 and the sensor 102; to the user interface 105; over the interface 116 between the circuit 104 and the memory 106; and over the interface 118 between the circuit 104 and the display 108.

During an exemplary on and/or active state of the apparatus 100, the circuit controller 120 directs and/or gates delivery of power from the power source 110 to the sensor 102, the user interface 105, the memory 106, and the display 108. During an off and/or inactive state of the apparatus 100, the circuit controller 120 halts, stops, and/or prevents delivery of power from the power source 110 to the sensor 102, the user interface 105, the memory 106, and the display 108. During a passive or sleep state, the circuit controller 120 directs, gates, and/or marshals reduced power to one or more of, and no power to a remaining one or more of, the sensor 102, the user interface 105, the memory 106, and/or the display 108.

An illustrative description of an exemplary operation of a digital camera as an implementation of the apparatus 100 is presented, for explanatory purposes. An exemplary feature of interest is instant review by the user 119 on the display 108 of an image and/or photo last taken. An exemplary display 108 comprises a lower resolution than a final print resolution that comes from an uncompressed version of the image stored in non-volatile memory as the memory 106. The display scaler 130 employs down sampling to create the image for instant review. The display scaler 130 creates a down-sampled file of the image. An exemplary speed demand to satisfy is a refresh rate of the display 108.

An QVGA LCD as an exemplary display 108 comprises an exemplary constraint and/or need to be supplied RGB 8-bit data at an exemplary and/or approximate rate of thirty (30) Mbtyes/second, for example, to satisfy, fulfill, and/or sustain an exemplary and/or approximate refresh rate of sixty (60) Hz for the QVGA LCD as the display 108. The down-sampled file in the memory 106 comprises a JPEG compressed YCC 4:2:2 format. After decompression of the down-sampled file by the decompression unit 128, the down-sampled file occupies two bytes per pixel. The display coordinator 132 converts the down-sampled file from YCC 4:2:2 to RGB.

The decompression unit 128 supplies the YCC data to the display coordinator 128 at a pace of twenty (20) Mbytes per second to meet, correspond, coordinate, and/or keep up with the exemplary and/or approximate rate of thirty (30) Mbtyes/second data rate for supply of the RGB 8-bit data to the QVGA LCD as an exemplary display 108. The decompression unit 128 comprises and/or shares one or more buffers 138 and/or 140 and the display coordinator 132 comprises and/or shares one or more buffers 138 and/or 140 such as two eight (8) line swing and/or ping pong buffers for decompression of eight by eight (8×8) blocks while simultaneously and/or contemporaneously driving data to the QVGA LCD as an exemplary display 108. The buffers 138 and/or 140 accommodate JPEG format of the down-sampled file in an 8×8 pixel transform and allow the decompression unit 128 to feed the display coordinator 132 for driving the display 108 in a line by line format. For example, one or more of the image receiver 124, the compression unit 126, the decompression unit 128, the display scaler 130, and/or the display coordinator 132 share the buffers 138 and/or 140. The buffers 138 and/or 140 comprise distinct and shared components in the circuit 104.

The JPEG compression ratio is programmable. In an exemplary implementation, a three or four to one compression ratio is sufficient and/or serves to reduce a bandwidth constraint for read by the memory controller 110 of NAND flash as an exemplary memory 106 to approximately and/or within fifty percent (50%) of an exemplary read potential bandwidth of seventeen (17) Mbytes per second over the interface 116 from the NAND flash as the memory 106.

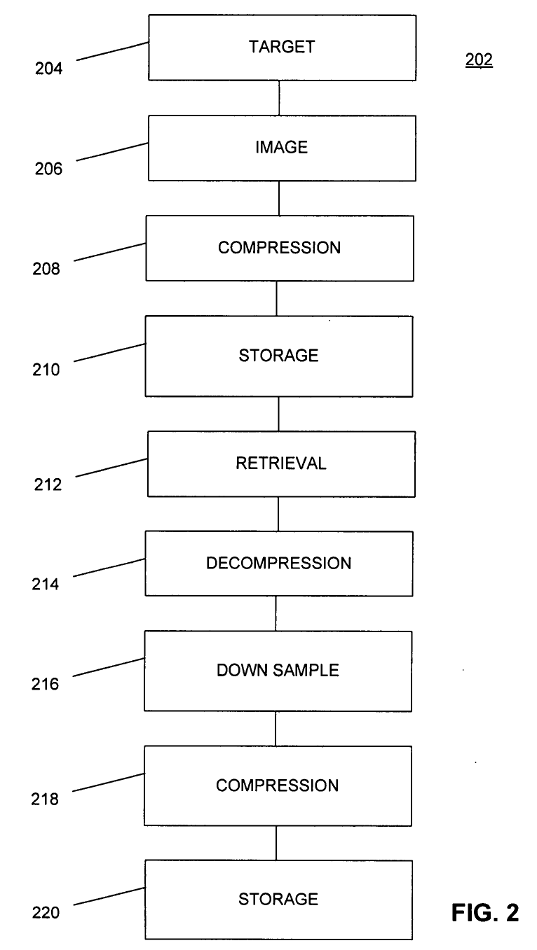

Turning to FIG. 2, in an exemplary logic flow 202 at STEP 204 the sensor 102 perceives, views, and/or observes an object and/or target such as a user 119. At STEP 206 the image receiver 124 captures an image of the object and/or target from the sensor 102. The image receiver 124 captures the image from the sensor 102 upon an operator as the user 119 pressing a trigger button and/or touching a point on a screen as an exemplary user interface 105, for example, to take a picture of the object and/or target.

At STEP 208 the compression unit 126 performs compression on the image. The compression unit 126 converts the image received from the image receiver 124 into a compressed format such as JPEG, for example, through a series of image processing operations. For example, the compression unit 126 performs JPEG compression on the image. At STEP 210 the memory controller 122 stores the compressed image in the memory 106. For example, the memory 106 comprises flash and/or non-volatile memory. The interface 116 between the compression unit 126 and the memory 106 may be relatively slow and the compression of the image promotes speed of transfer and/or communication over the interface 116.

At STEP 212 the memory controller 122 retrieves and/or obtains the compressed image from the memory 106. At STEP 214 the decompression unit 128 decompresses the previously-compressed image. At STEP 216 the display scaler 130 down samples the decompressed image to a lower level of resolution that is suitable, appropriate, needed, and/or sufficient for the display 108. The display scaler 130 creates a down-sampled file and/or version of the image that the display 108 will employ as a basis for providing instant and/or immediate review of the image last taken by the user 119.

At STEP 218 the compression unit 126 performs compression on the down-sampled image. At STEP 220 the memory controller 122 stores the compressed and down-sampled image in the memory 106. The original full version of the image remains present in compressed form in the memory 106. The down-sampled version of the image is also stored in compressed form in the memory 106. The compressed and down-sampled version of the image in the memory 106 serves as a display buffer for the display 108 such as for providing instant and/or immediate review of the image last taken by the user 119.

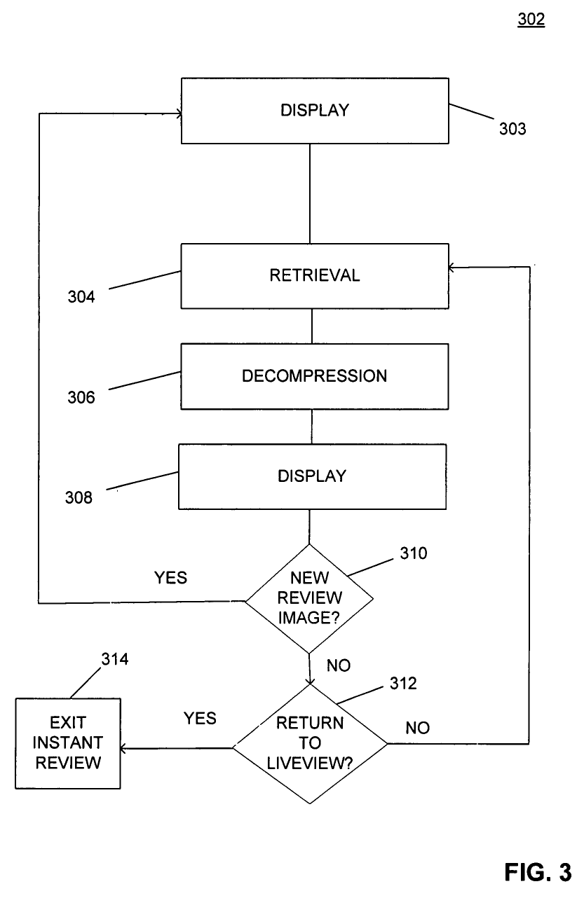

Turning to FIG. 3, in an exemplary logic flow 302 at STEP 303 the display 108 presents the down-sampled version of the image. At STEP 304 the memory controller 122 retrieves and/or obtains the compressed and down-sampled version of the image from the memory 106. At STEP 306 the decompression unit 128 decompresses the down-sampled version of the image. At STEP 308 the display coordinator 132 presents the down-sampled version of the image to the display 108, for example, to provide the instant and/or immediate review of the image last taken by the user 119. The display coordinator 132 accepts YCC 4:2:2 data in 8×8 blocks from the decompression unit 128 and maintains two eight (8) line swing buffers as the buffers 138 and/or 140 that feed an exemplary LCD data pipeline to the display 108. The display coordinator 132 converts YCC data to RGB data and applies desired, selected, needed, and/or appropriate gamma correction and/or filtering to the down-sampled image, for example, depending on and/or tuned to constraints and/or characteristics of the LCD as the display 108. STEPS 304, 306, and 308 repeat and/or iterate to refresh the display 108. For example, the memory controller 122 repeatedly and/or continuously such as until a completion event, retrieves a down-sampled version of the image from the memory 106 for refresh of the display 108. For exemplary instant and/or immediate review, the non-volatile memory controller 122 repeatedly and/or continuously until a completion event, retrieves the down-sampled version of the image from the memory 106 and sends the down-sampled version of the image through the decompression unit 128 and out the display coordinator 132 for refresh of the display 108.

In a first exemplary implementation, STEP 310 presents a decision such that exemplary iteration continues through STEP 304 while a same down-sampled image is a last-taken image. When a newer, more recent, and/or substitute down-sampled image becomes the last taken image then STEP 310 returns to STEP 303 to display the current down-sampled file. STEP 303 continues to STEP 304.

In a second exemplary implementation, STEP 310 presents a decision such that exemplary iteration proceeds through STEP 312 to continue through STEP 304 while a same down-sampled image is a last-taken image, unless the user 119 would decide to return to an exemplary liveview mode of the apparatus 100, so STEP 312 proceeds to STEP 314 for exit of an exemplary instant review mode of the apparatus 100.

In an exemplary implementation, a configuration of the user interface 105 may serve to determine and/or contribute to a timing and/or approach to a return to an exemplary liveview mode of the apparatus 100, such as at STEP 314. In an exemplary liveview mode of the apparatus 100 the sensor 102 serves to capture and/or obtain video data of a target and/or object such as the user 119. The image receiver 124 may process the video data and send the video data directly to the display coordinator 132 for display of the video data on the display 108. The sensor 102 supports video at an approximate and/or exemplary rate of sixty (60) frames per second, for example, to maintain, meet, and/or satisfy exemplary refresh needs, characteristics, desires, and/or constraints of an LCD as the display 108.

An exemplary implementation employs the down-sampled version of the image and routing of the down-sampled version of the image from the memory 106, to the memory controller 122, and through the decompression unit 128 and the display coordinator 132 out to the display 108, as a display buffer and/or a substitute for a display-dedicated memory buffer (not shown) such as volatile memory not present in the circuit 104 and/or a memory buffer (not shown) such as volatile memory present in the circuit 104 but not employed for refresh of the display 108.

An exemplary implementation comprises an algorithm, procedure, program, process, mechanism, engine, model, coordinator, module, application, software, code, and/or logic.

An exemplary implementation comprises a memory controller 122 that repeatedly retrieves a down-sampled file of a digitally captured image from a non-volatile memory 106 for refresh of a raster display screen 108.

A decompression unit 128 decompresses the down-sampled file of the digitally captured image from the non-volatile memory 106 to create a decompressed and down-sampled version of the digitally captured image that is employed for the refresh of the raster display screen 108. A display coordinator 132 receives the decompressed and down-sampled file of the digitally captured image from the decompression unit 128, wherein the display coordinator 132 employs the decompressed and down-sampled file of the digitally captured image for immediate review by a user 119 on the raster display screen 108. The memory controller 122, the decompression unit 128, and the display coordinator 132 employ the non-volatile memory 106 as a memory buffer for the down-sampled file of the digitally captured image for the refresh of the raster display screen 108.

The memory controller 122 stores in the volatile memory: a full file of the digitally captured image; and the down-sampled file of the digitally captured image. The memory controller 122 retrieves the down-sampled file of the digitally captured image from the non-volatile memory 106 and routes the down-sampled file of the digitally captured image for the refresh of the raster display screen 108. A display scaler 130 receives a full file of the digitally captured image and performs down sampling to create the down-sampled file of the digitally captured image. The memory controller 122 repeatedly retrieves the down-sampled file of the digitally captured image from the non-volatile memory 106 for: an initial presentation of the down-sampled file of the digitally captured image on the raster display screen 108; and one or more refreshes of the down-sampled file of the digitally captured image on the raster display screen 108.

The memory controller 122 repeatedly retrieves the down-sampled file of the digitally captured image from the non-volatile memory 106 at least and/or approximately commensurately with a refresh rate of the raster display screen 108 for the refresh of the raster display screen 108. An integrated circuit 104 comprises the memory controller 122. The non-volatile memory 106 is non-integrated with respect to the integrated circuit 104. The integrated circuit 104 repeatedly retrieves the down-sampled file of the digitally captured image from the non-volatile memory 106 that is non-integrated with respect to the integrated circuit 104 for the refresh of the raster display screen 108. The raster display screen 108 comprises a quarter video graphics array (QVGA) liquid crystal display (LCD) 108. The memory controller 122 participates in supply of the down-sampled file to the QVGA LCD 108 in satisfaction of a refresh rate of sixty (60) Hz for the QVGA LCD 108.

An exemplary approach employs a non-volatile memory 106 as a memory buffer for a down-sampled file of a digitally captured image for a refresh of a raster display screen 108.

Upon repeated retrieval of the down-sampled file of the digitally captured image from the non-volatile memory 106 for the refresh of the raster display screen 108, the down-sampled file of the digitally captured image is decompressed in corresponding repetition to create a decompressed and down-sampled version of the digitally captured image that is employed for the refresh of the raster display screen 108.

An exemplary implementation comprises means for employing a non-volatile memory 106 as a memory buffer for a down-sampled file of a digitally captured image for a refresh of a raster display screen 108.

The non-volatile memory 106 comprises flash memory. The raster display screen 108 comprises a liquid crystal display (LCD) display screen 108. The means for employing the flash memory as the memory buffer for the down-sampled file of the digitally captured image for the refresh of the LCD display screen 108 comprises: means for employing Joint Photographic Experts Group (JPEG) compression for storage of the down-sampled file of the digitally captured image in the flash memory and retrieval of the down-sampled file of the digitally captured image from the flash memory; and means for employing JPEG decompression to create a decompressed and down-sampled version of the digitally captured image that is employed for the refresh of the LCD display screen 108.

An exemplary implementation comprises a display coordinator 132 that provides instant review by a user 119 on a display screen 108 of a last-taken image through employment of a down-sampled version of the last-taken image retrieved from non-volatile memory 106.

A decompression unit 128 decompresses the down-sampled version of the last-taken image from the non-volatile memory 106 to create a decompressed and down-sampled version of the last-taken image. The decompression unit 128 passes the decompressed and down-sampled version of the last-taken image to the display coordinator 132. The display coordinator 132 employs the decompressed and down-sampled version of the last-taken image for the instant review by the user 119 on the display screen 108 of the last-taken image. The display coordinator 132 accepts YCrCb and/or YCC 4:2:2 format for the decompressed and down-sampled version of the last-taken image from the decompression unit 128 and maintains a plurality of buffers that feed an LCD data pipeline to the display screen 108 for the instant review by the user 119 on the display screen 108 of the last-taken image.

A display scaler 130 receives a full version of the last-taken image and performs down sampling to create the down-sampled version of the last-taken image for the instant review by the user 119 on the display screen 108 of the last-taken image. A memory controller 122 stores in the volatile memory: a full version of the last-taken image; and the down-sampled version of the last-taken image. The memory controller 122 retrieves the down-sampled version of the last-taken image from the non-volatile memory 106 and routes the down-sampled version of the last-taken image toward the display coordinator 132 for the instant review by the user 119 on the display screen 108 of the last-taken image. The memory controller 122 repeatedly retrieves the down-sampled version of the last-taken image from the non-volatile memory 106 at least and/or approximately commensurately with a refresh rate of the display screen 108 to allow the display coordinator 132 to provide the instant review by the user 119 on the display screen 108 of the last-taken image.

The display screen 108 comprises a lower resolution than a print resolution that is obtainable from a full version of the last-taken image.

A progressive image sensor 102 originates and transmits to a receiver 124 and compression unit 126 coupled with the memory controller 122, the last-taken image upon selection by the user 119. The progressive image sensor 102 outputs a red-green-blue (RGB), cyan-magenta-yellow (CMY), cyan-magenta-yellow-black (CMYK), and/or Bayer format of the last-taken image to the receiver 124. The receiver 124 outputs an YCrCb and/or YCC format of the last-taken image to the compression unit 126 for Joint Photographic Experts Group (JPEG) compression of the last-taken image.

A power source 110 provides power to the non-volatile memory 106 and the display screen 108 during an active state of the digital camera. The power source 110 withholds power from the non-volatile memory 106 and the display screen 108 during an inactive state of the digital camera.

A circuit controller 120 that during the active state of the digital camera directs delivery of power from the power source 110 to the non-volatile memory 106, the display screen 108, an image sensor 102, and a user interface 105. The circuit controller 120 during the inactive state of the digital camera stops delivery of power from the power source 110 to the non-volatile memory 106, the display screen 108, the image sensor 102, and the user interface 105. The circuit controller 120 during a sleep state of the digital camera causes the power source 110 to provide reduced power to one or more of, and no power to a remaining one or more of, the non-volatile memory 106, the display screen 108, the image sensor 102, and/or the user interface 105.

The display screen 108 comprises an LCD. The display coordinator 132 converts the down-sampled version of the last-taken image from YCC format to red-green-blue (RGB) format and applies gamma correction to the down-sampled version of the last-taken image tuned to constraints and/or characteristics of the LCD 108 for the instant review by the user 119 on the LCD 108 of the last-taken image.

An implementation of the apparatus 100 comprises a plurality of components such as one or more of electronic components, chemical components, organic components, mechanical components, hardware components, optical components, and/or computer software components. A number of such components can be combined or divided in an implementation of the apparatus 100. In one or more exemplary implementations, one or more features described herein in connection with one or more components and/or one or more parts thereof are applicable and/or extendible analogously to one or more other instances of the particular component and/or other components in the apparatus 100. In one or more exemplary implementations, one or more features described herein in connection with one or more components and/or one or more parts thereof may be omitted from or modified in one or more other instances of the particular component and/or other components in the apparatus 100. An exemplary technical effect is one or more exemplary and/or desirable functions, approaches, and/or procedures. An exemplary component of an implementation of the apparatus 100 employs and/or comprises a set and/or series of computer instructions written in or implemented with any of a number of programming languages, as will be appreciated by those skilled in the art. An implementation of the apparatus 100 comprises any (e.g., horizontal, oblique, angled, or vertical) orientation, with the description and figures herein illustrating an exemplary orientation of an exemplary implementation of the apparatus 100, for explanatory purposes.

An implementation of the apparatus 100 encompasses an article and/or an article of manufacture. The article comprises one or more computer-readable signal-bearing media. The article comprises means in the one or more media for one or more exemplary and/or desirable functions, approaches, and/or procedures.

An implementation of the apparatus 100 employs one or more computer readable signal bearing media. A computer-readable signal-bearing medium stores software, firmware and/or assembly language for performing one or more portions of one or more implementations. An example of a computer-readable signal bearing medium for an implementation of the apparatus 100 comprises a memory and/or recordable data storage medium of the circuit 104, the compression unit 126, memory controller 122, decompression unit 128, display scaler 130, and/or display coordinator 132. A computer-readable signal-bearing medium for an implementation of the apparatus 100 in an example comprises one or more of a magnetic, electrical, optical, biological, chemical, and/or atomic data storage medium. For example, an implementation of the computer-readable signal-bearing medium comprises one or more floppy disks, magnetic tapes, CDs, DVDs, hard disk drives, and/or electronic memory. In another example, an implementation of the computer-readable signal-bearing medium comprises a modulated carrier signal transmitted over a network comprising or coupled with an implementation of the apparatus 100, for instance, one or more of a telephone network, a local area network (“LAN”), a wide area network (“WAN”), the Internet, and/or a wireless network. A computer-readable signal-bearing medium comprises a physical computer medium and/or computer-readable signal-bearing tangible medium.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a memory controller that repeatedly retrieves a down-sampled file of a digitally-captured image from a non-volatile memory for refresh of a raster display screen.

2. The apparatus of claim 1, further comprising:
a decompression unit that decompresses the down-sampled file of the digitally-captured image from the non-volatile memory to create a decompressed and down-sampled version of the digitally-captured image that is employed for the refresh of the raster display screen.

3. The apparatus of claim 2, further comprising:
a display coordinator that receives the decompressed and down-sampled file of the digitally-captured image from the decompression unit, wherein the display coordinator employs the decompressed and down-sampled file of the digitally-captured image for immediate review by a user on the raster display screen.

4. The apparatus of claim 3, wherein the memory controller, the decompression unit, and the display coordinator employ the non-volatile memory as a memory buffer for the down-sampled file of the digitally-captured image for the refresh of the raster display screen.

5. The apparatus of claim 1, wherein the memory controller stores in the volatile memory:
a full file of the digitally-captured image; and
the down-sampled file of the digitally-captured image;
wherein the memory controller retrieves the down-sampled file of the digitally-captured image from the non-volatile memory and routes the down-sampled file of the digitally-captured image for the refresh of the raster display screen.

6. The apparatus of claim 1, further comprising:
a display scaler that receives a full file of the digitally-captured image and performs down sampling to create the down-sampled file of the digitally-captured image, wherein the memory controller repeatedly retrieves the down-sampled file of the digitally-captured image from the non-volatile memory for:
an initial presentation of the down-sampled file of the digitally-captured image on the raster display screen; and
one or more refreshes of the down-sampled file of the digitally-captured image on the raster display screen.

7. The apparatus of claim 1, wherein the memory controller repeatedly retrieves the down-sampled file of the digitally-captured image from the non-volatile memory at least commensurately with a refresh rate of the raster display screen for the refresh of the raster display screen.

8. The apparatus of claim 1 in combination with an integrated circuit that comprises the memory controller, wherein the non-volatile memory is non-integrated with respect to the integrated circuit;
wherein the integrated circuit repeatedly retrieves the down-sampled file of the digitally captured image from the non-volatile memory that is non-integrated with respect to the integrated circuit for the refresh of the raster display screen.

9. The apparatus of claim 1, wherein the raster display screen comprises a quarter video graphics array (QVGA) liquid crystal display (LCD), wherein the memory controller participates in supply of the down-sampled file to the QVGA LCD in satisfaction of a refresh rate of sixty (60) Hz for the QVGA LCD.

10. A method, comprising the step of:
employing a non-volatile memory as a memory buffer for a down-sampled file of a digitally-captured image for a refresh of a raster display screen.

11. The method of claim 10, wherein the step of employing the non-volatile memory comprises the step of:
upon repeated retrieval of the down-sampled file of the digitally-captured image from the non-volatile memory for the refresh of the raster display screen, decompressing the down-sampled file of the digitally-captured image in corresponding repetition to create a decompressed and down-sampled version of the digitally-captured image that is employed for the refresh of the raster display screen.

12. An apparatus, comprising:
means for employing a non-volatile memory as a memory buffer for a down-sampled file of a digitally-captured image for a refresh of a raster display screen.

13. The apparatus of claim 12, wherein the non-volatile memory comprises flash memory, wherein the raster display screen comprises a liquid crystal display (LCD) display screen, wherein the means for employing the flash memory as the memory buffer for the down-sampled file of the digitally-captured image for the refresh of the LCD display screen comprises:
means for employing Joint Photographic Experts Group (JPEG) compression for storage of the down-sampled file of the digitally-captured image in the flash memory and retrieval of the down-sampled file of the digitally-captured image from the flash memory; and
means for employing JPEG decompression to create a decompressed and down-sampled version of the digitally-captured image that is employed for the refresh of the LCD display screen.

14. A digital camera, comprising:
a display coordinator that provides instant review by a user on a display screen of a last-taken image through employment of a down-sampled version of the last-taken image retrieved from non-volatile memory.

15. The digital camera of claim 14, further comprising:
a decompression unit that decompresses the down-sampled version of the last-taken image from the non-volatile memory to create a decompressed and down-sampled version of the last-taken image, wherein the decompression unit passes the decompressed and down-sampled version of the last-taken image to the display coordinator, wherein the display coordinator employs the decompressed and down-sampled version of the last-taken image for the instant review by the user on the display screen of the last-taken image.

16. The digital camera of claim 15, wherein the display coordinator accepts YCC 4:2:2 format for the decompressed and down-sampled version of the last-taken image from the decompression unit and maintains a plurality of buffers that feed an LCD data pipeline to the display screen for the instant review by the user on the display screen of the last-taken image.

17. The digital camera of claim 14, further comprising:
a display scaler that receives a full version of the last-taken image and performs down sampling to create the down-sampled version of the last-taken image for the instant review by the user on the display screen of the last-taken image.

18. The digital camera of claim 14, further comprising:
a memory controller that stores in the volatile memory:
a full version of the last-taken image; and
the down-sampled version of the last-taken image;
wherein the memory controller retrieves the down-sampled version of the last-taken image from the non-volatile memory and routes the down-sampled version of the last-taken image toward the display coordinator for the instant review by the user on the display screen of the last-taken image.

19. The digital camera of claim 18, wherein the memory controller repeatedly retrieves the down-sampled version of the last-taken image from the non-volatile memory at least commensurately with a refresh rate of the display screen to allow the display coordinator to provide the instant review by the user on the display screen of the last-taken image.

20. The digital camera of claim 14 in combination with the display screen, wherein the display screen comprises a lower resolution than a print resolution that is obtainable from a full version of the last-taken image.

21. The digital camera of claim 14, further comprising:
a progressive image sensor that originates and transmits to a receiver and compression unit coupled with the memory controller, the last-taken image upon selection by the user.

22. The digital camera of claim 21 in combination with the receiver, wherein the progressive image sensor outputs a red-green-blue (RGB), cyan-magenta-yellow (CMY), cyan-magenta-yellow-black (CMYK), and/or Bayer format of the last-taken image to the receiver, wherein the receiver outputs an YCC format of the last-taken image to the compression unit for Joint Photographic Experts Group (JPEG) compression of the last-taken image.

23. The digital camera of claim 14, further comprising:
a power source that provides power to the non-volatile memory and the display screen during an active state of the digital camera;
wherein the power source withholds power from the non-volatile memory and the display screen during an inactive state of the digital camera.

24. The digital camera of claim 23, further comprising:
a circuit controller that during the active state of the digital camera directs delivery of power from the power source to the non-volatile memory, the display screen, an image sensor, and a user interface;
wherein the circuit controller during the inactive state of the digital camera stops delivery of power from the power source to the non-volatile memory, the display screen, the image sensor, and the user interface;
wherein the circuit controller during a sleep state of the digital camera causes the power source to provide reduced power to one or more of, and no power to a remaining one or more of, the non-volatile memory, the display screen, the image sensor, and/or the user interface.

25. The digital camera of claim 14, wherein the display screen comprises an LCD, wherein the display coordinator converts the down-sampled version of the last-taken image from YCC format to red-green-blue (RGB) format and applies gamma correction to the down-sampled version of the last-taken image tuned to constraints of the LCD for the instant review by the user on the LCD of the last-taken image.
